(19) United States
(12) Patent Application Publication
(10) Pub. No.: US 2016/0001711 A1
(43) Pub. Date: Jan. 7, 2016

(54) Trailer Hitch Ball Mount Holder and Storage System

(71) Applicant: Timothy L. Hughes, Lake Park, GA (US)

(72) Inventor: Timothy L. Hughes, Lake Park, GA (US)

(21) Appl. No.: 14/791,251

(22) Filed: Jul. 2, 2015

Related U.S. Application Data
(60) Provisional application No. 62/019,983, filed on Jul. 2, 2014.

(51) Int. Cl. B60R 9/06

(52) U.S. Cl. CPC B60R 9/06

(57) ABSTRACT

A trailer hitch ball mount holder and storage system includes a receiver opening for receiving a stem of a ball mount in a holder cross member. Angular elongate leg members spatially separate foot members of the holder cross member from the foot members. The holder cross member includes pin apertures for storage of ball mount pins, and a leg member includes R-clip apertures for storage of clips. A leg member also includes a cable aperture for attachment of a cable to lock and secure the ball mount accessories to the ball mount holder. The ball mount holder foot members are attached to a vehicle surface, such as the bed of a pickup truck.

### PRIORITY CLAIM

The present application claims benefit of U.S. provisional patent application No. 62/019,983 to Timothy L. Hughes filed on Jul. 2, 2014.

### FIELD OF THE INVENTION

The present invention relates to a holder for storage on a vehicle of a ball mount and accessories of a ball hitch, in which the ball mount includes a stem as received on a receiver tube of a vehicle while the ball mount is in use.

### BACKGROUND OF THE INVENTION

Ball hitches are a well known method for towing various types of trailers from vehicles such as SUVs and pickup trucks. The use of ball mounts for ball hitches are commonly used in connection with a receiver that is mounted on a frame of the vehicle, and the ball mount is slidably mounted within the receiver by insertion of a stem. The ball mount generally comprises a ball supported on a flat bar comprising a ball shank that is connected to a square tube comprising the stem. A suitable locking pin is received within co-operating apertures in both the receiver and the stem of the ball mount for retaining the ball mount within the receiver. Different sizes of balls for ball hitches may be mounted on their own respective ball mounts having a single ball shank so that the receiver mounts one ball therein at a given time. A ball mount may include ball shanks with apertures for mounting several balls of different sizes at a time, and the correct desired size of ball is selected by turning the selected ball upwards when inserting the stem into the receiver tube.

When a ball hitch is not in use, it is recommended to remove the ball mount from the receiver for storage. Typically, the ball mount or plurality of ball mounts for different sized balls are loosely laid in the bed of a pickup truck, placed in a truck, or left in the cargo area of an SUV. This situation makes the ball mount less accessible and less secure. The ball mount may be stolen or may damage the vehicle by sliding and moving about in the truck bed or the like. Thus, proper storage is needed for the ball mount and the accessories used with the ball mount such as the pin, clip, and ball. A good storage is especially needed to make these items easy to access from the bed of a pickup truck so that a person does not have to climb into the truck to obtain the parts of a ball mount.

### SUMMARY OF THE INVENTION

According to an aspect of the present invention, there is provided a holder device for temporary storage of a ball mount having a stem. The holder is mounted and supported on a vehicle, such as the bed of a pickup truck. The stem is slidably received within a receptacle on the holder. A ball may be supported on the stem or the device during storage.

The holder comprises a mount with foot members for attachment and support of the device on the vehicle, and angular leg members extending from the foot members to a holder cross member attached between the two angular legs to provide a horizontal support cross member for receiving elements from the ball mount. In particular, the stem of the ball mount is received by an elongate receiver receptacle that includes an aperture in the receiver on the holder cross member for storage of the ball mount while not in use. The cross member is attached between the upper terminal ends of the leg members, and the received is centrally located on the cross member.

According to a further aspect of the invention, the holder cross member includes a receiver for the stem of a ball mount within the holder cross member, and the holder cross member includes additional pin apertures in the form of four holes located through the surface of the holder cross member. In the preferred embodiment, the pin apertures are situated equidistant spaced about the periphery of receiver in the holder cross member sufficiently spaced to provide for receiving ball mount pins within the pin apertures without interfering with reception of the stem of the ball mount. An R-clip may be used in each pin to secure the each pin within the respective pin apertures.

According to another aspect of the invention, at least one of the holder leg members includes R-clip apertures through the surface of the leg members for receiving R-clips that are spring cotter pins known as hitch pin clips. One or more R-clip apertures may be included on the leg member. The R-clip apertures are located near the edge of leg member, sufficiently close to the edge that the straight leg portion of the R-clip is inserted into the R-clip aperture, and the semicircular “belly” in the middle of the other, R-shaped leg, is pushed about the outside edge of the leg member. The bent leg of the belly of the R-clip grips the outside of the leg member resisting any force removing the R-clip from its hole defining the R-clip aperture.

In another aspect, the holder includes a cable aperture for attachment of a cable. The cable aperture in the preferred embodiment passes through a central portion of a leg member for securing one end of the cable by a loop and bolt of sufficient size to prevent removal of the cable while attached. The opposing end of the cable from the one that is attached to the cable aperture is manipulated to run a portion of the cable through a pin aperture of the ball mount stem or a loop of the ball mount pins to secure the elements of the trailer hitch ball mount to the holder for secure storage. A loop may be formed in the end of the cable opposing the attached end, whereby the two ends of the cable may be secured together by a standard padlock 50 or combination lock as shown in FIG. 3.

When mounting the holder in a vehicle, the preferred practice would be to mount the legs vertically so that the stem of the ball mount in received by the holder in an up and down arrangement. However, in certain situations, horizontal mounting of the holder may be desirable. The holder can be mounted horizontally with the stem of the ball mount secured within the receptacle of the holder cross member by inserting a ball mount pin into the stem. All of the other features of the holder will also function normally and retain a selection of ball mount pins or R-clips in the appropriate locations on the holder.

An object of the invention is to provide a device that attaches easily to the bed of a pickup truck.

Another object is to make a device that is compact and able to fit either in the front of a pickup truck bed or behind the wheel well depending on the truck bed.

Yet another object would be to make a device that does not protrude beyond the wheel well when mounted behind such location in the bed of a pickup truck, thereby not further limiting the width of the truck's bed. Such device should prevent any protruding into the bed width of any ball mount, ball mount pins or R-clips that are being stored.

Still another object would be to provide a device that can secure the ball mount, as well as a plurality of ball mount pins and R-clips by locking those accessories onto the storage device so as to deter any theft.

These and other objects and advantages are addressed fully and provide for by the description of the embodiments of a trailer hitch ball mount holder and storage system that follow.

### BRIEF DESCRIPTION OF THE DRAWINGS

FIG. 1 is a front perspective view of a trailer hitch ball mount holder storage device and system according to an embodiment of the disclosure.

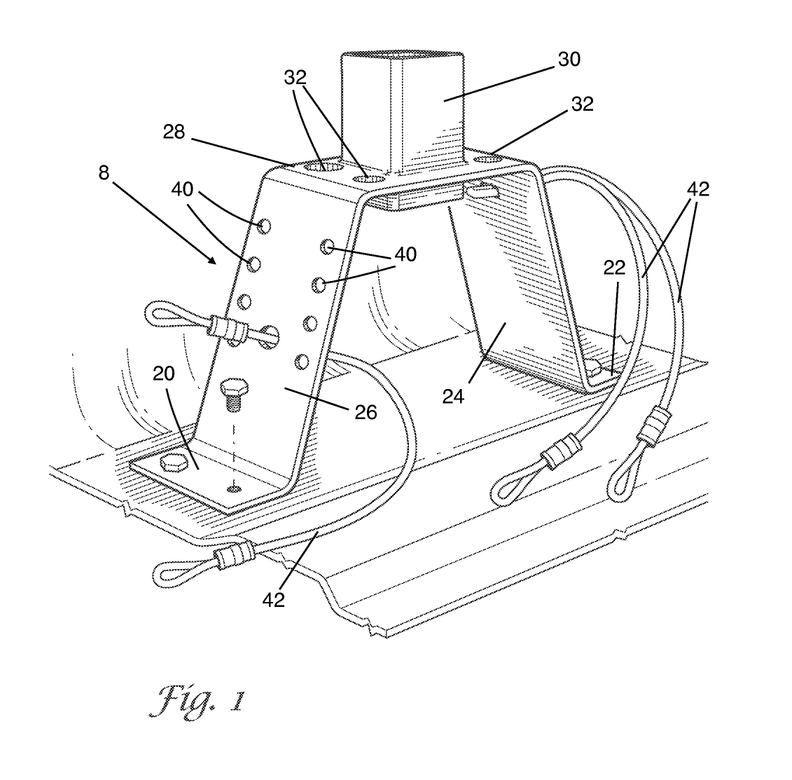

FIG. 2 is a perspective view of an embodiment of the invention holding a trailer hitch ball mount.

FIG. 3 is a perspective view of an embodiment of the invention illustrating pins retained by apertures in a holder cross member.

### DETAILED DESCRIPTION

Referring to the accompanying drawings there is illustrated a ball mount holder 8 and storage system for use with a ball mount 10 having a stem 12. The ball mount with stem is commonly found with vehicle trailer hitch systems having a square tubular receiver supported on the vehicle. The stem of the ball mount is normally slidably received within the receiver of the vehicle that is bolted or welded into place on the frame of the vehicle.

The ball mount holder is indicated generally by reference numeral 8 and is intended to receive and store a ball mount 10 by receiving the stem 12 when the ball mount is not in use as a trailer hitch. The ball mount 10 includes a ball 14 that is mounted using a bolt and nut onto a flat bar 16 that is attached to the stem 12 of the ball mount, or the ball is mounted to a threaded aperture that is formed into a portion of the stem of the ball mount.

In the exemplary embodiment disclosed in the drawings, the ball mount holder 8 includes a metal fabricated mount structure in the form of a raised bridge in which a cross member 28 is spatially separated by the bridge from a vehicle surface for separation of the stem when stored from the vehicle. The structure of the ball mount holder 8 includes a pair of spatially separated first and second foot members 20, 22. Each foot member comprises a plate that includes a bottom horizontally flat surface that is flush with the surface of the vehicle where the structure is mounted. A distance between the leg members provides spatial separation and clearance between the foot members for stability and for clearance with the device for receiving a ball mount stem, pins, and separates the foot members and R-clips by the ball mount holder as discussed further herein. The first foot member 20 and the second foot member 22 each include mounting apertures 23 as a means for securing the foot members to the vehicle body by a reliable attachment means. Most people will attach the foot members to the bed of a pickup truck using bolts. Additional padding may be provided between the foot members and the vehicle to prevent damage to the vehicle and minimize ratting of the holder and stored elements during transportation. In addition, the holder may be sprayed with a shock absorbing coating to further minimize movement of stored elements and rattling.

The structure of the ball mount holder includes elongated first and second leg members 24, 26 extending upward from the foot members 20, 22. The embodiment disclosed illustrates the leg members being attached to the foot members by welding or bending the leg portions from the foot members. The first leg member 24 and the second leg member 26 each extend vertically at an angle when considered from the reference point of the foot members being mounted to a horizontal surface of the vehicle. The angle of the elongate leg members 24, 26 causes the bottom ends of the leg members to be further apart than the top ends of the leg members, adding stability to the ball mount holder. The distance between the top ends of the leg members provides sufficient distance between them to provide for receiving a ball mount stem 12 and accessories.

The top ends of the leg member 24, 26 are connected by a holder cross member 28 forming a bridge across the gap between the legs. The holder cross member may be formed by bending the structure of the metal fabricated mount or by welding a member between the two legs. By bending the mount structure during fabrication, the entire structure of the foot members, leg members and holder cross member may be fabricated out of a single length of flat metal. The holder cross member that is formed is drilled, milled or cut to form several apertures for storage of ball mount components. In the holder cross member, a receiver opening 30 is formed to receive and secure the stem of a ball mount. In the exemplary embodiment, the receiver opening is a raised square tubular member designed to match the size and shape of a standard receiver of a vehicle, and the receiver opening is formed in the center of the holder cross member 28. The receiving opening being elongate or raised from the surface of the holder cross member increases the stability of the ball mount 10 with the holder by minimizing movement of the stem 12.

One or more pin apertures 32 may be provided through the holder cross member 28. The pin apertures are formed by drilling four holes through the surface of the holder cross member. In the embodiment of the drawings, four of the pin apertures 32 are situated equidistant and spaced about the periphery of receiver in the holder cross member. These pin apertures are each preferably spaced apart about one-inch from the periphery of the receiver opening 30 to provide sufficient space for receiving ball mount pins 34 within the pin apertures without interfering with the reception of the stem of the ball mount in the receiver opening. After the ball mount pins are stored in the pin apertures, an R-clip 36 may be used in each pin by insertion in the hole toward the bottom end of the pin to secure each pin within the respective pin apertures 32. The top end of the ball mount pin 34 will generally include a ring clip or bend that will prevent the top end of the ball mount pin from sliding through the pin aperture.

One or more R-clip apertures 38 may be provided through the surface of one of the leg members 24, 26. In the drawings, the R-clip apertures 38 are formed in the first leg member 24 as shown. The R-clip apertures receive R-clips 36 for storage as an accessory to the ball mount 10. The standard R-clip 36 used with ball mounts includes a straight leg portion and a semicircular belly portion in the middle of a R-shaped curved leg portion. The two leg portions of the R-clip are attached together to form a spring with a first curved semi-circular end and a second end with two independent and separable tips. The R-clip apertures are located near the edge of leg member 24, whereby the straight leg portion of the R-clip 36 is inserted into the R-clip aperture 38, and the semicircular belly in the middle of the other curved leg portion, R-shaped leg, is pushed about the outside edge of the leg member. The bent leg of the belly of the R-clip grips the outside of the leg member resisting any force removing the R-clip from its hole defining the R-clip aperture.

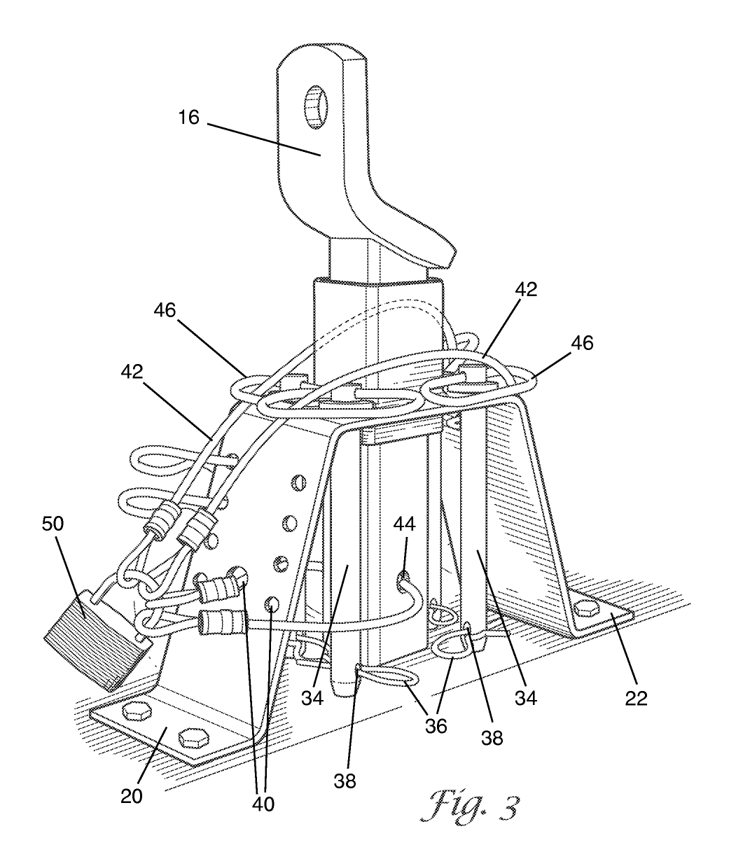

The ball mount holder 8 includes a cable aperture 40 for attachment of a cable 42. The cable aperture 40 in the described embodiment passes through a central portion of the leg member 24 for securing one end of the cable 42 by a loop and bolt of sufficient size to prevent removal of the cable while attached. The opposing end of the cable from the one that is attached to the cable aperture is manipulated to run a portion of the cable through a pin aperture 44 of the ball mount stem 12 or a loop 46 of the ball mount pins 34 to secure the elements of the trailer hitch ball mount 10 to the holder 8 for secure storage. A loop may be formed in the end of the cable 42 opposing the attached end. The unattached end of the cable permits each of the elements of the ball mount including accessories such as the ball mount pins to be secured by running the cable through those elements. The loose unattached end may be brought back around to the affixed end that is attached to the cable aperture, where the two ends of the cable 42 may be secured together by a standard padlock or combination lock as shown in FIG. 3.

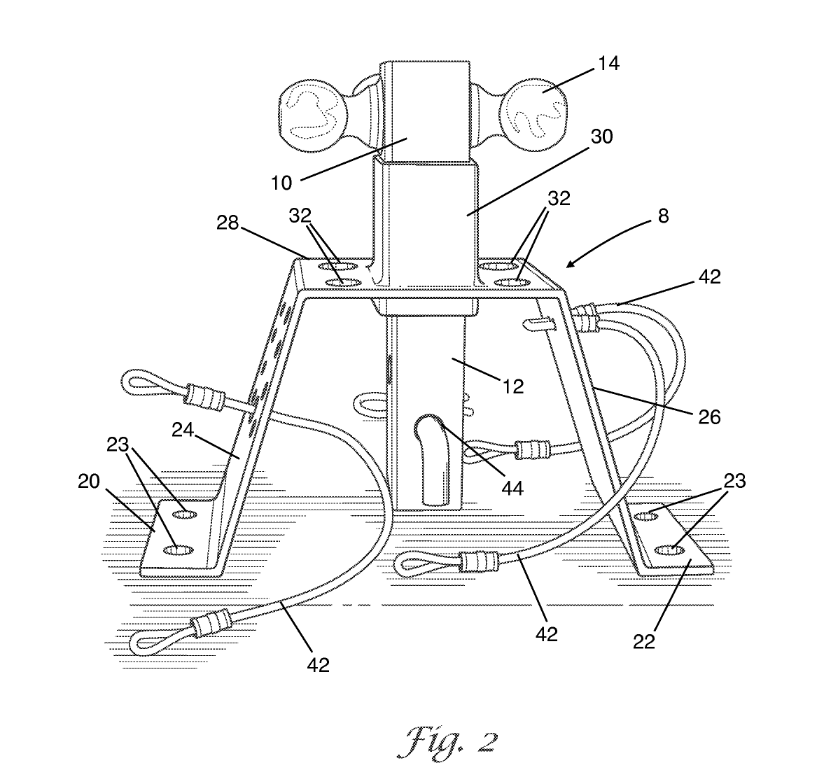

Referring to FIG. 2 an embodiment of the holder 8 is shown with a ball mount stem 12 inserted into the receiver opening 30 of the holder cross member 28. The particular ball mount 10 includes several balls 14 of different sizes attached to the stem by threaded apertures in the stem. The cable 42 is affixed to the cable aperture 40. The holder is able to secure the ball mount for storage without a ball mount pin or with a ball mount pin as shown. Alternative, the holder is able to secure a ball mount 11 as shown in FIG. 3 in which the stem of the ball mount includes a flat plate attached to the ball mount where the ball 14 would be received and attached by a bolt of the ball and a nut. This type of ball mount may also be secured within the holder by simply placing the stem within the receiver 30 of the holder cross member 28. The ball mount 10 may be further secured with insertion of a ball mount pin into the pin hole 44 on the stem 12, or by running the cable 42 through the pin hole of the stem as shown in FIG. 3.

Referring to FIG. 3, the holder 8 is shown storing a ball mount 10 and a set of four extra ball mount pins 34. The extra ball mount pins 34 are secured in the pin apertures 32 by the common loops attached to the tops of the pins and by the R-clip 36 inserted through the opposite end of the pins. An additional ball mount pin may be inserted into the pin hole 44 in the stem 12 of the ball mount as shown in FIG. 2. In FIG. 2 the extra ball mount pins are removed to illustrate the positioning of the pin apertures about the receiver opening in more detail. In the embodiment shown, one pin aperture is located in each corner of the holder cross member.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. A trailer hitch ball mount holder comprising:
a. opposing elongate leg members, said leg members including a plurality of apertures, whereby the apertures may receive clips or pins for storage thereof;
b. a cross member attached between upper terminal ends of the opposing leg members, said cross member including a plurality of apertures, whereby the apertures may receive one or more ball mount pins;
c. a foot member attached to a lower terminal end of each opposing leg member, whereby the foot members are spatially separated and support the holder on a surface;
d. a means for mounting each said foot member to the surface;
e. a receiver with an opening for receiving a stem of a ball mount in a said received centrally located on said cross member; and
f. at least one leg member includes an aperture for attachment of a cable to lock and secure the ball mount accessories to the ball mount holder. The ball mount holder foot members are attached to a vehicle surface, such as the bed of a pickup truck.
